(19) United States
(12) Patent Application Publication
(10) Pub. No.: US 2023/0394058 A1
(43) Pub. Date: Dec. 7, 2023

(54) DEVICE, SERVER, ASSOCIATION INFORMATION ACQUIRING SYSTEM, ASSOCIATION INFORMATION ACQUIRING METHOD, AND RECORDING MEDIUM

(71) Applicant: SHARP KABUSHIKI KAISHA, Sakai City (JP)

(72) Inventors: KOHJI MIYAUCHI, Sakai City (JP); Nobuo OGATA, SakaiCity (JP)

(21) Appl. No.: 18/204,657

(22) Filed: Jun. 1, 2023

(30) Foreign Application Priority Data
Jun. 1, 2022 (JP) 2022-089314
Apr. 6, 2023 (JP) 2023-061818

(51) Int. Cl. G06F 16/25

(52) U.S. Cl. CPC G06F 16/254

(57) ABSTRACT

A device includes: a search key generator that acquires a plurality of items of device information and generates a search key including the plurality of items of device information; and a communicator that transmits the search key to a server that extracts association information associated with the search key and receives the association information from a server that stores the association information.

### BACKGROUND OF THE INVENTION

### Field of the Invention

The present disclosure relates to a device, a server, association information acquiring system, an association information acquiring method, and a recording medium. This application claims the priority based on Patent Application No. 2022-089314 filed in Japan on Jun. 1, 2022, and Patent Application No. 2023-061818 filed in Japan on Apr. 6, 2023, the contents of which are hereby incorporated herein.

### Description of the Background Art

In the related art, a technique of displaying keywords to narrow down manual information, accepting a keyword selected by a user from among the displayed keywords, and retrieving manual information corresponding to the accepted keyword and version information from a server is known.

In the technique known in the related art, when the user makes a mistake in selecting a keyword, the user may not obtain the manual information necessary for the user. Therefore, an aspect of the present disclosure is to provide a device, a server, an association information acquiring system, an association information acquiring method, and a recording medium that can acquire appropriate information according to a status of the device.

### SUMMARY OF THE INVENTION

According to an aspect of the present disclosure, a device includes a search key generator that acquires a plurality of items of device information and generates a search key including the plurality of items of device information, and a communicator that transmits the search key to a server that extracts association information associated with the search key and receives the association information from the server that stores the association information.

According to another aspect of the present disclosure, a server includes a search key acquirer that acquires a search key including a plurality of items of device information acquired by a device, and an association information extractor that extracts, from a database including association information associated with a combination of device information, association information associated with a combination of device information that matches the device information included in the search key.

According to still another aspect of the present disclosure, an association information acquiring system includes the device and the server.

According to a further aspect of the present disclosure, an association information acquiring method includes acquiring a plurality of items of device information, generating a search key including the plurality of items of device information, transmitting the search key to a server that extracts association information associated with the search key, and receiving the association information from the server that stores the association information.

According to a still further aspect of the present disclosure, a non-transitory computer readable recording medium recording a program causes a computer to execute acquiring a plurality of items of device information, generating a search key including the plurality of items of device information, transmitting the search key to a server that extracts association information associated with the search key, and receiving the association information from the server that stores the association information.

### BRIEF DESCRIPTION OF THE DRAWINGS

FIG. 1 is a diagram illustrating an example of an overall configuration of an association information acquiring system.

FIG. 2 is a block diagram illustrating a configuration of a device according to a first embodiment.

FIG. 3A is a diagram illustrating an example of a plurality of items of device information and tags attached to the individual items when an operation status of the device of the first embodiment is a normal operation status.

FIG. 3B is a diagram illustrating an example of a plurality of items of device information and tags attached to the individual items when an operation status of the device of the first embodiment is an error status.

FIG. 3C is a diagram illustrating an example of a plurality of items of device information and tags attached to the individual items when an operation status of the device of the first embodiment is a setting change status.

FIG. 4A is a diagram illustrating an example of a search key including the plurality of items of device information illustrated in FIG. 3A.

FIG. 4B is a diagram illustrating an example of a search key including the plurality of items of device information illustrated in FIG. 3B.

FIG. 4C is a diagram illustrating an example of a search key including the plurality of items of device information illustrated in FIG. 3C.

FIG. 5 is a block diagram illustrating an example of a server configuration.

FIG. 6 is a flowchart of an example of an operation of an association information acquiring system according to the first embodiment.

FIG. 7A is a diagram illustrating an example of an association information database including reference information indicating file names.

FIG. 7B is a diagram illustrating an example of an association information database including reference information indicating URLs.

FIG. 8 is a diagram illustrating an example of presentation information indicating association information.

FIG. 9 is a diagram illustrating an example of a plurality of items of device information and tags attached to the individual items when a plurality of external connection methods of a device of a second embodiment is employed.

FIG. 10 is a diagram illustrating an example of a search key including the plurality of items of device information illustrated in FIG. 9.

FIG. 11 is a flowchart of an example of an operation of extracting and representing the plurality of pieces of association information in an association information acquiring system according to the second embodiment.

FIG. 12 is a diagram illustrating an example of presenting, in sequence, a plurality of presentation information indicating the plurality of pieces of association information about the external connection method.

FIG. 13 is a diagram illustrating an example of selection of a plurality of presentation information using presentation information indicating a table of contents.

FIG. 14 is a block diagram illustrating an example of a configuration of a device according to a third embodiment including an external device type identifier.

FIG. 15 is a diagram illustrating an example of a plurality of items of device information including a device type and tags attached to the individual items in a device according to a third embodiment.

FIG. 16 is a diagram illustrating an example of a search key including the plurality of items of device information illustrated in FIG. 15.

FIG. 17 is a diagram illustrating an example of a plurality of presentation information indicating association information for individual external connection methods.

FIG. 18 is a block diagram illustrating an example of a configuration of a device according to a fourth embodiment.

FIG. 19 is a block diagram illustrating an example of a configuration of a server according to the fourth embodiment.

FIG. 20 is a block diagram illustrating an example of a configuration of a device according to a fifth embodiment.

### DESCRIPTION OF THE PREFERRED EMBODIMENTS

### First Embodiment

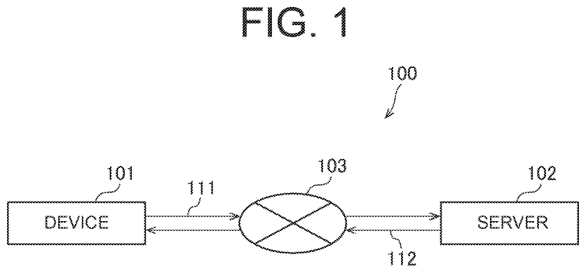

A first embodiment will be described with reference to the FIGS. 1 to 8. For the drawings, the same reference numerals are attached to the same or equivalent elements, and duplicate explanations will be omitted. (The same applies below.)

FIG. 1 is a diagram illustrating an example of an overall configuration of an association information acquiring system 100. The association information acquiring system 100 includes a device 101 and a server 102. The device 101 communicates with the server 102 via a network 103.

The device 101 is an information processing apparatus including a communicator. For example, the device 101 is a display, such as a television set, or an electronic device, such as a home appliance. The device 101 acquires a plurality of items of device information indicating a status of the device 101, generates a search key 111 including the plurality of acquired items of device information, and transmits the search key 111 to the server 102 through the network 103. The device 101 then obtains association information 112 associated with the search key 111 from the server 102. The association information 112 includes information according to at least one status selected from a group including a setting status of the device 101, an operation status of the device 101, and an external connection status of the device 101. For example, the association information 112 indicates information on an instruction manual regarding functions, operational settings, maintenance, and responses to errors of the device 101.

The server 102 is an information processor that extracts the association information 112 associated with the search key 111.

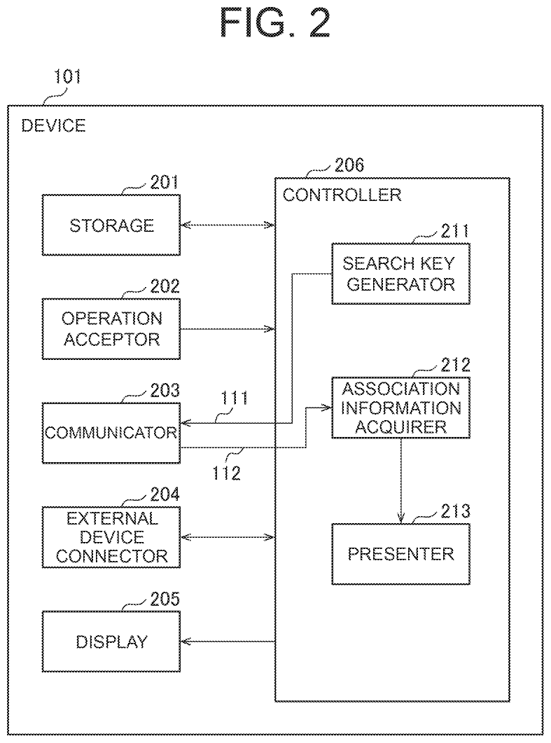

FIG. 2 is a block diagram illustrating an example of a configuration of the device 101. The device 101 includes a storage 201, an operation acceptor 202, a communicator 203, an external device connector 204, a display 205, and a controller 206.

The storage 201 is a recording medium capable of recording various data, programs, etc., and is a storage device, such as a RAM (Random Access Memory), a hard disk drive, or a flash memory. The storage 201 stores a plurality of items of device information and device control programs. The device information stored in the storage 201 is updated every time a status of the device 101 is changed.

The operation acceptor 202 accepts an operation of a user requesting the association information 112. For example, the operation acceptor 202 accepts an operation of the user requesting the association information 112 by means of operation buttons (not shown) of the device 101 or a remote controller.

The communicator 203 is an interface for performing communication via the network 103. Specifically, the communicator 203 transmits the search key 111 to the server 102 and receives the association information 112 from the server 102.

The external device connector 204 is an interface for connection to an external device. For example, the external device connector 204 is an interface for connection to a wired connection device via an HDMI (High-Definition Multimedia Interface), a USB (Universal Serial Bus), a LAN (Local Area Network), etc., and a wireless connection device via a wireless LAN or Bluetooth (registered trademark).

The display 205 displays various types of information including the association information 112. For example, the display 205 is a liquid crystal panel or an organic electroluminescence (EL) panel.

The controller 206 executes various processes in accordance with a device control program and data stored in the storage 201. For example, the controller 206 is realized using a processor, such as a CPU (central processing unit).

The controller 206 includes a search key generator 211, an association information acquirer 212, and a presenter 213.

The search key generator 211 acquires a plurality of items of device information and generates a search key 111 including the plurality of items of device information. Specifically, the search key generator 211 retrieves the plurality of items of device information from the storage 201, triggered by a user operation requesting the association information 112, and generates a search key 111 including the retrieved items of device information. The plurality of items include at least one item selected from a group including an item regarding a setting status of the device 101, an item regarding an operation status of the device 101, and an item regarding an external connection status of the device 101. The item associated with the external connection status include an item regarding an external connection method.

The association information acquirer 212 acquires the association information 112 received by the communicator 203.

The presenter 213 presents the association information 112 to the user.

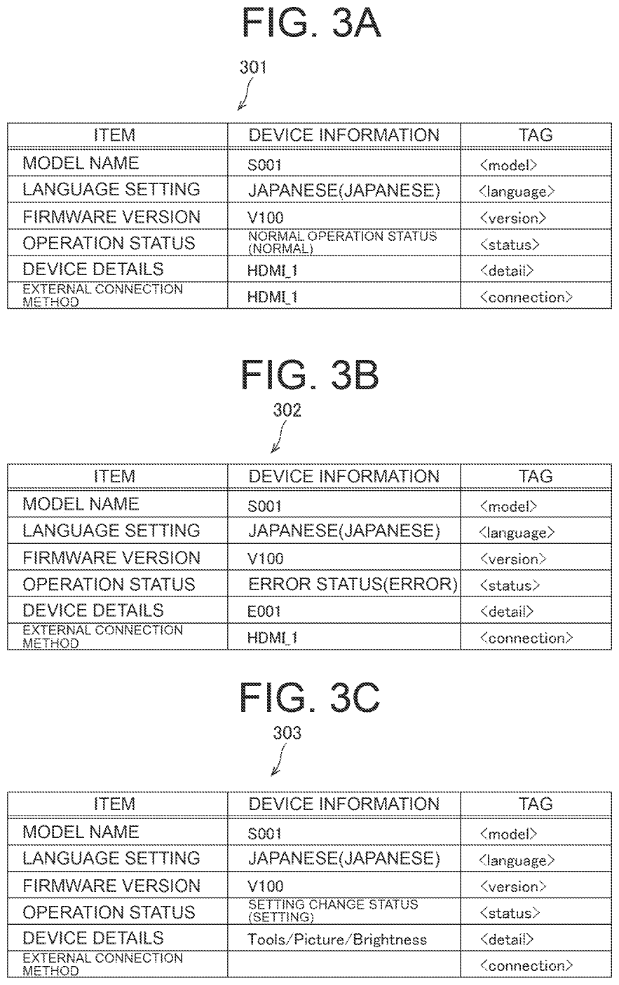

FIG. 3A is a diagram illustrating an example of the plurality of items of device information 301 and tags attached to the respective items when an operation status of the device 101 is a normal operation status. The plurality of items of device information 301 indicate a model name, a language setting, a firmware version, an operation status, device details, and an external connection method.

The plurality of items of device information 301 indicate that the model name is S001, the language setting is Japanese, the firmware version is V100, and the operation status is a normal operation status. Furthermore, the device information indicating the device details is linked to the operation status of the device 101, and when the operation status of the device 101 is the normal operation status, the device details indicate a display input corresponding to the normal operation status. For example, when the device 101 is receiving a TV broadcast of digital television (DTV), BS, or CS, display of an HDMI input signal is shown in the example in FIG. 3A. When the device 101 includes a plurality of HDMI terminals, the device information indicating the device details is numbered at an end thereof, such as HDMI_1 and HDMI_2, so that an HDMI terminal being connected is identified. This identification is required because different HDMI terminals may have different supported functions and different association information.

As illustrated in FIG. 3A, the items of the model name, the language setting, the firmware version, the operation status, the device details, and the external connection method are tagged with “model”, “language”, “version”, “status”, “detail”, and “connection”, respectively.

FIG. 3B is a diagram illustrating an example of the plurality of items of device information 302 and tags attached to the respective items when the operation status of the device 101 is an error status. The items and the tags illustrated in FIG. 3B are the same as the items and the tags illustrated in FIG. 3A, and therefore, detailed descriptions thereof are omitted. (The same applies below.)

The device information indicating the device details is linked to the operational status of the device 101. When the device 101 is in an error status, the device information indicating the device details indicates that an error assigned to an error code (e.g., E001) has occurred. Specifically, a case where an error has occurred while an HDMI input signal illustrated in FIG. 3A is being displayed is illustrated. At this time, the operation status switches from NORMAL to ERROR and the device details switch from HDMI_1 to the error code (E001). The device information indicating the external connection method remains HDMI_1.

FIG. 3C is a diagram illustrating an example of the plurality of items of device information 303 and tags attached to the respective items when the operation status of the device 101 is a setting change status. The plurality of items of device information 303 indicate that the operation status is the setting change status, the device details indicate a status of adjusting brightness (Brightness) in picture quality (Picture) of a settings menu (Tools), and there is no external connection.

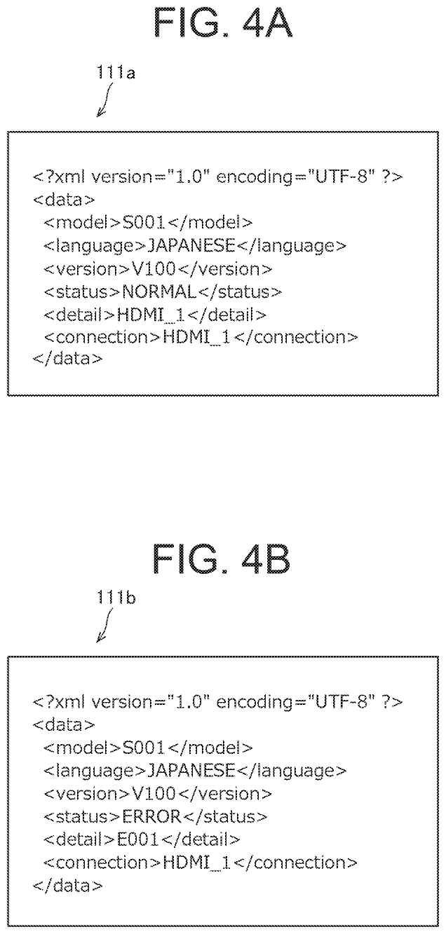

FIG. 4A is a diagram illustrating an example of a search key 111a including the plurality of items of device information 301 illustrated in FIG. 3A. The search key 111a illustrated in FIG. 4A shows the device information 301 in an XML format, with the individual items tagged as illustrated in FIG. 3A. Specifically, in the case of the XML format, the items of the device information are described between start and end tags of the respective tags shown in FIG. 3A. Although FIG. 4A shows the search key 111a in the XML format, the search key 111a may be in any other format as long as required device information in the plurality of items of device information 301 are included without omission.

As illustrated in FIG. 4A, the search key 111a indicates the model name, the language setting, the firmware version, the operation status, the device details, and the external connection method indicated by the plurality of items of device information 301 illustrated in FIG. 3A. Furthermore, as illustrated in FIG. 4A, when the item of the device information 301 corresponding to the operation status of the device 101 indicates the normal operation status, the search key 111a is linked to the operation status of the device 101, and the device information tagged with “detail” indicates HDMI_1. The device information indicating HDMI_1 indicates that the device 101 inputs or outputs signals via the HDMI.

FIG. 4B is a diagram illustrating an example of a search key 111b including the plurality of items of device information 302 illustrated in FIG. 3B. The search key 111b illustrated in FIG. 4B shows the device information 302 in the XML format, with the individual items tagged as illustrated in FIG. 3B.

As illustrated in FIG. 4B, when the item of the device information 302 corresponding to the operation status of the device 101 indicates the error status, the search key 111b includes the device information 302 indicating an error code. That is, the device information corresponding to the device details is linked to the operation status of the device 101, and when the operation status is the error status, the device information tagged with “detail” indicates the error code (E001, for example) in the search key 111b.

FIG. 4C is a diagram illustrating an example of a search key 111c including the plurality of items of device information 303 illustrated in FIG. 3C. The search key 111c illustrated in FIG. 4C shows the device information 303 in the XML format, with the individual items tagged as illustrated in FIG. 3C.

Furthermore, as illustrated in FIG. 4C, when the item of the device information 303 corresponding to the operation status of the device 101 indicates the setting change status, the device information tagged with “detail” indicates “Tools/Picture/Brightness” in the search key 111c. The device information indicates that the device 101 is in the process of adjusting the brightness in a settings menu. Here, the device information corresponding to the external connection method is left blank, which means that there is no external connection, and the external connection method of the device information is indicated by an empty element.

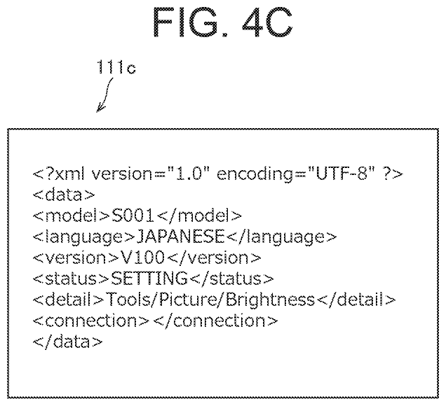

FIG. 5 is a block diagram illustrating an example of a configuration of the server 102. The server 102 includes a storage 501, a communicator 502, and a controller 503.

The storage 501 is a recording medium capable of recording various data, programs, etc., and is a storage device, such as a RAM, a hard disk drive, or a flash memory. The storage 501 stores an association information database 511 and a server control program. The association information database 511 stores information for referencing the association information 112 in a subdivided manner according to all combinations of device information corresponding to search keys. In the following description, the device information registered in the association information database 511 is referred to as index information. Note that the information stored in the association information database 511 for referencing the association information 112 is referred to as reference information. For example, when the association information 112 is data of the instruction manual for the device 101, the reference information indicates a storage destination of the instruction manual data.

The communicator 502 is an interface for performing communication via the network 103. Specifically, the communicator 502 receives the search key 111 from the device 101 and transmits the association information 112 extracted by the association information extractor 513 to the device 101. The search key 111 received by the communicator 502 includes the plurality of items of device information obtained by the device 101.

The controller 503 executes various processes in accordance with server control programs and data stored in the storage 501. For example, the controller 503 is realized using a processor, such as a CPU.

The controller 503 includes a search key acquirer 512 and an association information extractor 513.

The search key acquirer 512 acquires the search key 111 received by the communicator 502 and transmits the search key 111 to the association information extractor 513.

The association information extractor 513 extracts, from the association information database 511, the association information 112 associated with a combination that matches the device information included in the search key 111. Here, it is preferable that the device information includes device information regarding the operation status of the device.

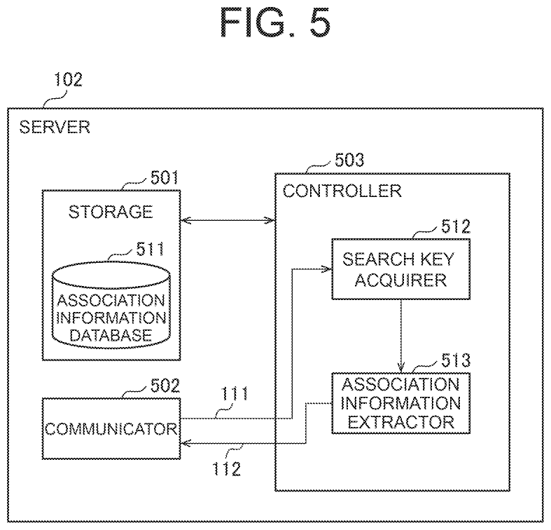

FIG. 6 is a flowchart of an example of an operation of the association information acquiring system 100 according to this embodiment. It is assumed that, at a time point when the device 101 starts a process of step S601 illustrated in FIG. 6, the device 101 is ready to communicate with the server 102.

In step S601, the search key generator 211 determines whether the operation acceptor 202 has accepted a user operation requesting the association information 112. For example, when the user performs an operation of requesting the association information 112 using a button of the device 101 or a remote controller, the operation acceptor 202 determines that the user's operation of requesting the association information 112 has been accepted.

When the operation acceptor 202 has not accepted the user operation of requesting the association information 112 in step S601, the controller 206 returns to the process in step S601. On the other hand, when the operation acceptor 202 receives a user operation of requesting the association information 112 in step S601, the search key generator 211 obtains, from the storage 201, a plurality of items of device information corresponding to a status of the device at that time in step S602.

In step S603, the search key generator 211 generates a search key 111 based on the plurality of items of device information obtained in step S602. By this, the search key 111 may be generated without missing the plurality of obtained items of device information. Furthermore, since the search key 111 is generated by obtaining the plurality of items of device information corresponding to the status of the device, it is possible to prevent generation of search keys 111 that have nothing to do with the status of the device 101.

In step S604, the communicator 203 transmits the search key 111 to the server 102.

When the communicator 502 receives the search key 111 in step S605, the search key acquirer 512 acquires the received search key 111 and transmits the search key 111 to the association information extractor 513.

In step S606, the association information extractor 513 specifies, in the association information database 511, a combination of the index information that matches the device information included in the search key 111.

In step S607, the association information extractor 513 extracts the association information 112 with reference to the reference information associated with the combination of index information specified in step S606.

Here, the association information 112 may be stored not only in the association information database 511, but also in a server (not shown) different from the server 102. For example, when the reference information indicates a URL for accessing the instruction manual data, the association information extractor 513 is connected to a destination of the URL from the communicator 502 via the network 103 and acquires the instruction manual data indicated by the URL as the association information 112. Since the URL of a server different from the server 102 is employed as the reference information, there is no need to store all the data in the instruction manual in the association information database 511. It is assumed that the server 102 is installed in a country A and the association information database 511 includes index information associated with the device 101 used in a country B and index information associated with the device 101 used in a country C. In this case, the association information database 511 includes a URL of a server installed in the country B as the reference information regarding the device 101 used in the country B, and a URL of a server installed in the country C as the reference information regarding the device 101 used in the country C. The instruction manual data for the device 101 used in the country B is stored in a memory of the server installed in the country B. The instruction manual data for the device 101 used in the country C is stored in a memory of the server installed in the country C. Accordingly, maintenance of the instruction manual data is improved because the association information 112 can be distributed and stored in the plurality of servers instead of storing all the instruction manual data in the association information database 511 of the server 102.

Therefore, the association information extractor 513 extracts the association information 112 associated with a combination that matches the items of device information included in the search key 111 by performing the process from step S606 and step S607. Since the search key 111 includes the plurality of items of device information indicating the status of the device 101, the association information extractor 513 can extract the association information 112 corresponding to the status of the device 101.

In step S608, the communicator 502 transmits the association information 112 extracted in step S607 to the device 101. Since the server 102 stores the association information 112, the device 101 is not required to store the association information 112. Accordingly, a memory for storing the association information 112 is not required for each device 101, and a memory cost for the device 101 may be suppressed.

When the communicator 203 receives the association information 112 from the server 102 in step S609, the association information acquirer 212 acquires the received association information 112 and transmits the association information 112 to the presenter 213.

In step S610, the presenter 213 presents the association information 112 to the user. Specifically, the presenter 213 converts the association information 112 to fit a form of presentation of the association information 112. In the following description, information that has been converted to fit the form of the presentation of the association information 112 is referred to as presentation information. For example, when displaying the association information 112 on the display 205, the presenter 213 converts the association information 112 into presentation information. In this case, the presentation information includes text and images to be displayed on the display 205. Alternatively, the presenter 213 may transmit the association information 112 to a terminal different from the device 101. Examples of the terminal different from the device 101 include a smartphone. Alternatively, when the device 101 includes a speaker (not shown), the presenter 213 may convert the association information so that the speaker outputs audio indicating the association information 112. In this case, the presentation information is an audio signal for outputting audio indicating the association information 112 from the speaker.

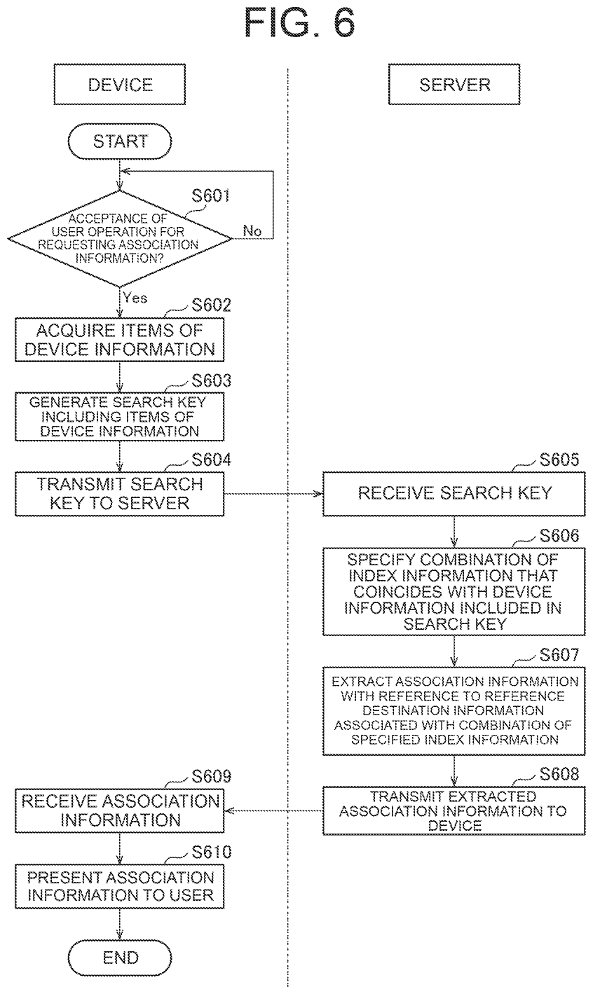

FIG. 7A is a diagram illustrating an example of the association information database 511 including the reference information indicating file names. In FIG. 7A, the index information and the reference information are represented in the XML format.

In a region 701, the index information indicated by “model”, which is a tag associated with a model name, is S001. In addition, the index information indicated by “language”, which is a tag for a language setting, is JAPANESE. Furthermore, the index information indicated by “version”, which is a tag about a firmware version, is V100. Moreover, in the region 701, the index information and the reference information associated with the device details in the respective operation statuses of ERROR, NORMAL, and SETTING are described in a hierarchical structure. Specifically, index information listed within a range sandwiched between <ERROR> and </ERROR> is associated with a case where the operation status is the error status. Index information listed within a range sandwiched between <NORMAL> and </NORMAL> is associated when the operation status is the normal operation status. Index information listed within a range sandwiched between <SETTING> and </SETTING> is associated with a case where the operation status is the setting change status. Furthermore, the reference information associated with the operation status and the device details is shown in the region 701 as a character string sandwiched between <manual> and </manual>.

In the following description, a process of extracting reference information from the association information database 511 by specifying a region that matches at least one device information included in the search key 111b in turn in the hierarchical manner when the operation status is the error status is described as an example. Furthermore, for convenience of explanation, the following description will be made taking regions 702 and 703 included in the region 701 as examples. In the region 702 included in the region 701, index information indicated by the tag “status” regarding the operation status, is ERROR. The region 702 includes index information regarding the error code of E001 and index information regarding the error code of E002.

It is assumed that the search key acquirer 512 acquires the search key 111b illustrated in FIG. 4B. In this case, the association information extractor 513 extracts, from the association information database 511, the region 701 that matches the model name, the language setting, and the firmware version indicated by the device information included in the search key 111b. Then the association information extractor 513 extracts, from the region 701, the region 702 in which the index information indicated by the tag “status” regarding the operation status is ERROR. Then the association information extractor 513 extracts, from the region 702, the region 703 in which index information indicated by the tag “detail” regarding the device details is E001. Then, the association information extractor 513 extracts reference information indicated by the tag “manual” immediately after the region 703.

For example, reference information indicating “C:¥data/S001_JAPANESE_V100_E001.html” indicates a file name of the instruction manual of the device 101 corresponding to the error to which the error code E001 is assigned with respect to the model name, the language setting, and the firmware version indicated by the plurality of items of device information included in the search key 111b. When the data of the instruction manual for the device 101 is stored in the server 102, the data of the instruction manual corresponding to the error code E001 described in this file is extracted as the association information 112.

FIG. 7B is a diagram illustrating an example of the association information database 511 including reference information indicating URLs. The same sections as in FIG. 7A are omitted. The only difference from FIG. 7A is a method of specifying the reference information.

When the data of the instruction manual of the device 101 is stored on a different server than the server 102, a URL of the instruction manual of the device 101 is used as the reference information, as illustrated in FIG. 7B. For example, reference information indicating “https:// . . . /S001/JAPANESE/V100/E001.html” indicates a URL of the instruction manual of the device 101 corresponding to the error to which the error code E001 is assigned with respect to the model name, the language setting, and the firmware version indicated by the plurality of items of device information included in the search key 111b. In this case, by referring to that URL, the association information extractor 513 extracts the instruction manual data corresponding to the error to which the error code of E001 is assigned, as the association information 112, with respect to the model name, the language setting, and the firmware version indicated by the plurality of items of device information included in the search key 111b. In the above description, an example of the association information database 511 in the XML format is described, but other formats may be employed as long as index information and reference information are registered without omission.

Note that the search key 111b includes device information tagged with “connection” which indicates the external connection method. However, for the user, when the operation status of the device 101 is the error status, it is more desirable to obtain the association information 112 regarding the device information indicating an error code in order to resolve an error, rather than to obtain the association information 112 regarding the external connection method. Therefore, when the operation status of the device 101 is the error status, the server 102 obtains only the association information 112 regarding the device information indicating the error code. Therefore, the association information 112 that has a relatively high priority for the user may be preferentially presented in accordance with the operation status of the device 101.

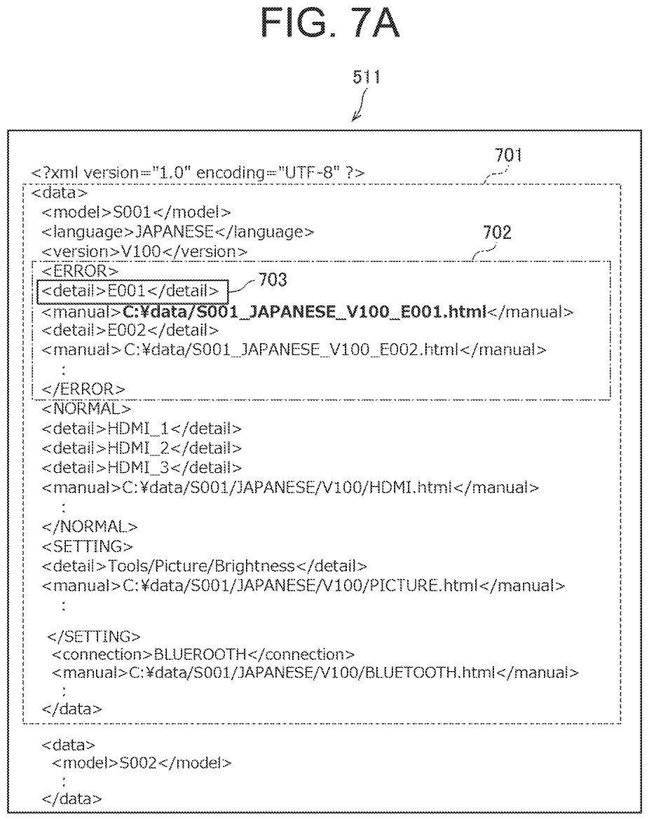

FIG. 8 is a diagram illustrating an example of presentation information 801 indicating the association information 112 regarding the error code of E001. For example, the description of the error code E001 shown in presentation information 801 indicates a phenomenon of the error, a countermeasure, and information that may be helpful to the user with respect to the error to which the error code of E001 is assigned.

As described above, according to the association information acquiring system 100 of this embodiment, the device 101 acquires device information indicating a status of the device and generates the search key 111 without the user specifying a keyword, and therefore, appropriate information can be acquired in accordance with the status of the device.

### Second Embodiment

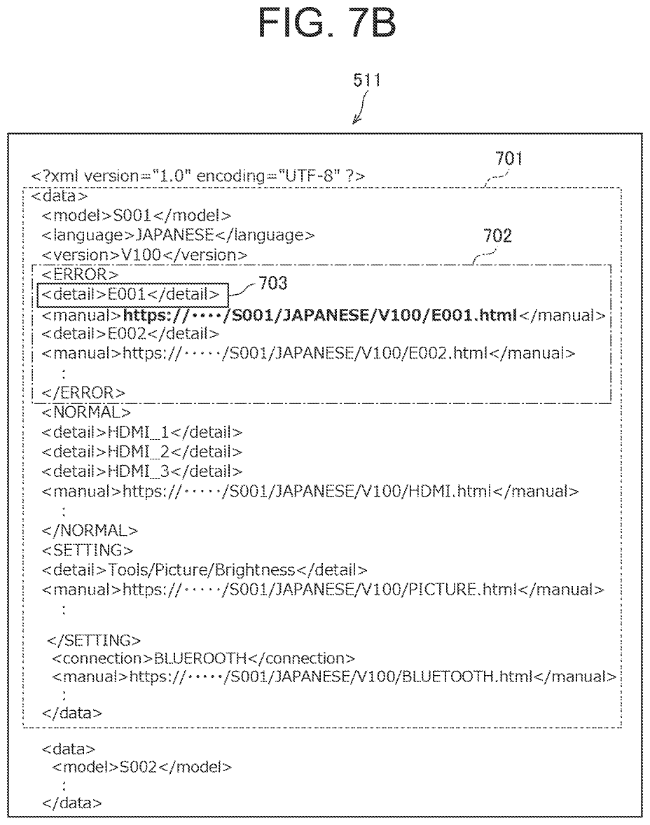

Referring to FIGS. 9 to 13, the second embodiment will be described. Here, a device 101 is in a normal operation status and has a plurality of external connections. Note that, components and processes having substantially the same functions as those in the other embodiment will be referred to with the common reference signs, and the descriptions thereof are omitted. (The same applies below.)

A presenter 213 in this embodiment presents a plurality of pieces of association information 112 regarding at least one of a plurality of items of device information.

FIG. 9 is a diagram illustrating an example of a plurality of items of device information 901 and tags attached to the respective items when a plurality of external connection methods of the device 101 is employed.

Among the plurality of items of device information 901, the device information indicating the external connection method indicates that the device 101 makes connections via the plurality of external connection methods, that is, Bluetooth, USB, LAN, and HDMI_1.

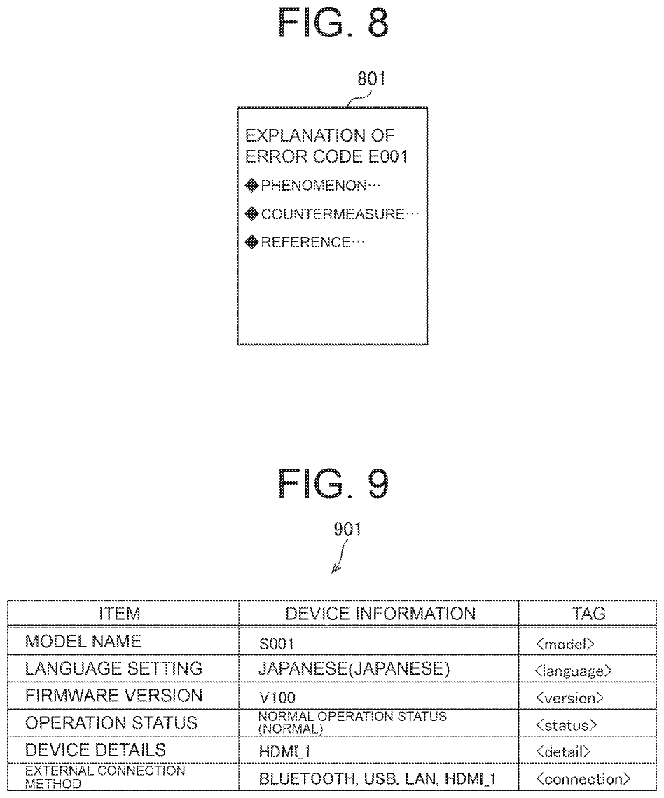

FIG. 10 is a diagram illustrating an example of a search key 111d including the plurality of items of device information 901 illustrated in FIG. 9. The search key 111d illustrated in FIG. 10 shows the device information 901 in the XML format, with the individual items tagged as illustrated in FIG. 9.

In the search key 111d, a tag “connection” is attached to the plurality of device information. Specifically, the tag “connection” is attached to device information indicating BLUETOOTH, device information indicating USB, device information indicating LAN, and device information indicating HDMI_1.

A configuration of a server 102 according to this embodiment is as illustrated in FIG. An association information extractor 513 according to this embodiment extracts, from an association information database 511, a plurality of pieces of association information 112 associated with a combination of the items of device information that matches the device information included in the search key 111.

Specifically, a communicator 502 according to this embodiment transmits the plurality of pieces of association information 112 extracted by the association information extractor 513 to the device 101.

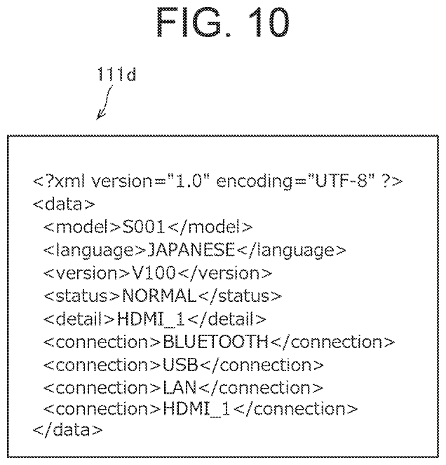

FIG. 11 is a flowchart of an example of an operation of extracting and representing the plurality of pieces of association information in an association information acquiring system 100 according to this embodiment. A process from step S1101 to step S1105 illustrated in FIG. 11 is the same as the process from step S601 to step S605 illustrated in FIG. 6, and therefore, a detailed description thereof is omitted.

When the search key acquirer 512 acquires the search key 111 in step S1105, the association information extractor 513 identifies, in the association information database 511, a plurality of index information that match the plurality of device information included in a combination of device information indicated by the search key in step S1106.

In step S1107, the association information extractor 513 extracts, from the association information database 511, the plurality of pieces of association information 112 and the like with reference to the plurality of reference information associated with plurality of index information identified in step S1106. Specifically, the association information extractor 513 of this embodiment can extract the plurality of pieces of association information 112, unlike the association information extractor 513 of the first embodiment, depending on the operation status, an external connection status, and the like of the device 101.

In step S1108, the communicator 502 transmits the plurality of pieces of association information 112 extracted in step S1107 to the device 101.

When the communicator 203 receives the plurality of pieces of association information 112 from the server 102 in step S1109, the association information acquirer 212 acquires the plurality of received association information 112 and transmits the plurality of received association information 112 to a presenter 213.

In step S1110, the presenter 213 presents the association information 112 selected from among the plurality of acquired association information 112 to the user. For example, when an operation acceptor 202 accepts an operation of selecting the association information 112 presented to the user, the presenter 213 presents the selected association information 112 to the user.

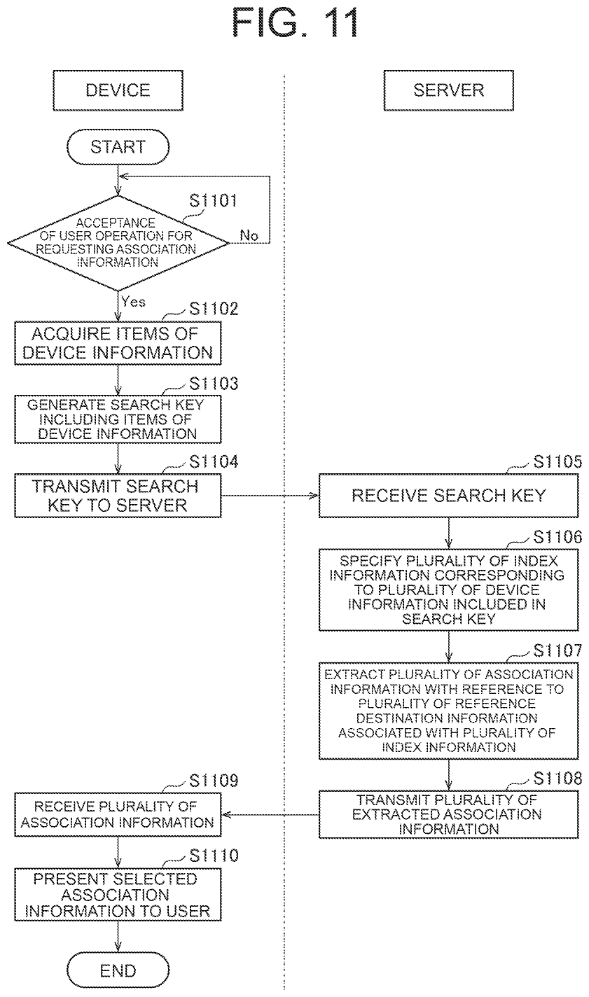

FIG. 12 is a diagram illustrating an example of presenting, in sequence, presentation information 1201 to presentation information 1204 indicating a plurality of pieces of association information regarding the external connection method. The presentation information 1201 to the presentation information 1204 indicate the association information 112 associated with the device information tagged with a tag “connection” illustrated in FIGS. 9 and 10.

The presenter 213 displays the presentation information 1201 to the presentation information 1204 on the display 205 in order. In such a case, the presenter 213 may perform switching among the presentation information 1201 to the presentation information 1204 in response to a user operation and display the presentation information on the display 205. By this, the presenter 213 can present to the user the association information 112 requested by the user out of the plurality of pieces of association information 112 according to the status of the device 101.

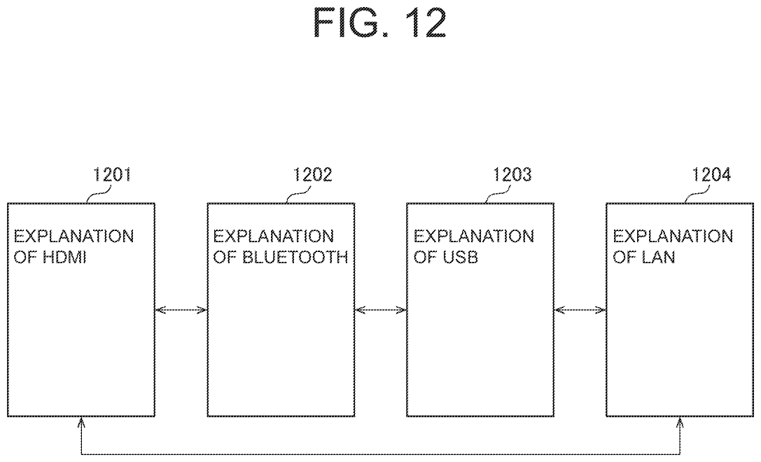

FIG. 13 is a diagram illustrating an example of a selection of a plurality of presentation information 1301 to presentation information 1304 indicating the plurality of pieces of association information 112 regarding the external connection method using presentation information 1305 indicating a table of contents. The presentation information 1301 to the presentation information 1304 indicate the plurality of pieces of association information 112 associated with the plurality of items of device information included in the search key 111d illustrated in FIG. 10.

The presentation information 1305 indicates a screen of a table of contents regarding the presentation information 1301 to the presentation information 1304. Items of HDMI, BLUETOOTH, USB, and LAN shown in the presentation information 1305 are a table of contents for individually presenting the presentation information 1301 to the presentation information 1304.

For example, when an operation acceptor 202 receives a user operation to select the item of HDMI, the item of BLUETOOTH, the item of USB, or the item of LAN, while the presenter 213 displays the presentation information 1305 on the display 205, the presenter 213 displays presentation information selected from among the presentation information 1301 to the presentation information 1304 on the display 205 in accordance with the selected item.

As described above, the presenter 213 can present the presentation information 1301 to the presentation information 1304 regarding the item selected by the user to the user and improve convenience for the user. Furthermore, the presenter 213 can display the presentation information 1301 to the presentation information 1304 on the display 205 more quickly than the presentation information 1301 to the presentation information 1304 displayed on display 205 in sequence.

As described above, according to the association information acquiring system 100 of this embodiment, the device 101 can appropriately present a plurality of pieces of association information 112 to the user in accordance with a status of the device 101.

### Third Embodiment

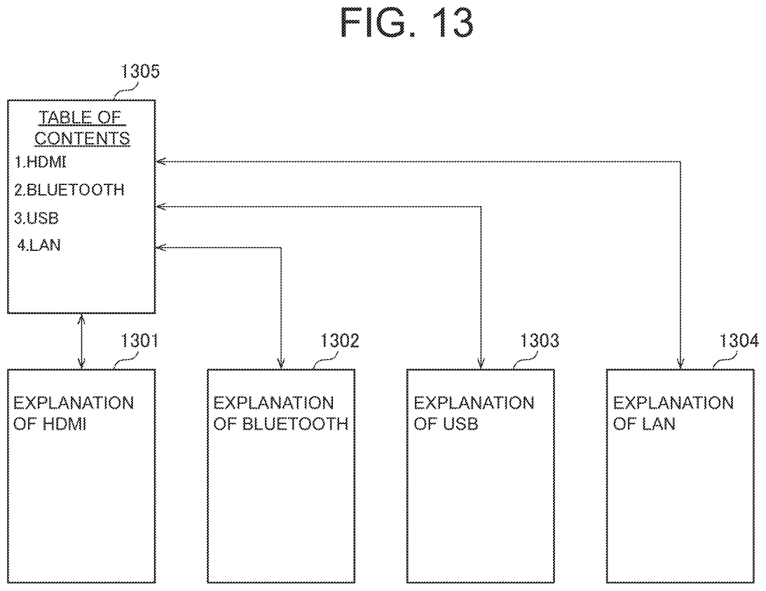

Referring to FIGS. 14 to 17, a third embodiment will be described. Here, a type of external device, such as a model name of the external device to which a device 101 is connected is identified, and association information corresponding to the determined type is presented.

FIG. 14 is a block diagram illustrating an example of a configuration of the device 101 according to this embodiment. The configuration of the device 101 illustrated in FIG. 14 is different from the device 101 illustrated in FIG. 2 in that the device 101 illustrated in FIG. 14 has an external device type identifier 1401 and a presenter 213 presents association information 112 according to the type of external device connected to the device 101.

The external device type identifier 1401 identifies a type of external device connected to the device 101. The type of external device includes not only a classification type, but also more detailed information, such as a model name.

A search key generator 211 in this embodiment generates a search key 111 that includes device information indicating a type of external device identified by the external device type identifier 1401. A search key generator 211 then sends the generated search key 111 to a server 102 via a network 103.

A configuration of the server 102 according to this embodiment is illustrated in FIG. 5.

When the search key 111 according to this embodiment includes device information indicating a model name of the external device connected to the device 101, an association information extractor 513 acquires association information 112 associated with the external device having the model name indicated by the device information from an information processing apparatus that is different from the server 102, such as an information processing apparatus managed by a manufacturer of the external device. Specifically, the association information extractor 513 retrieves a URL that indicates an instruction manual for the external device with the model name indicated by the device information via the Internet, and acquires data of the instruction manual for the external device indicated by the retrieved URL as the association information 112.

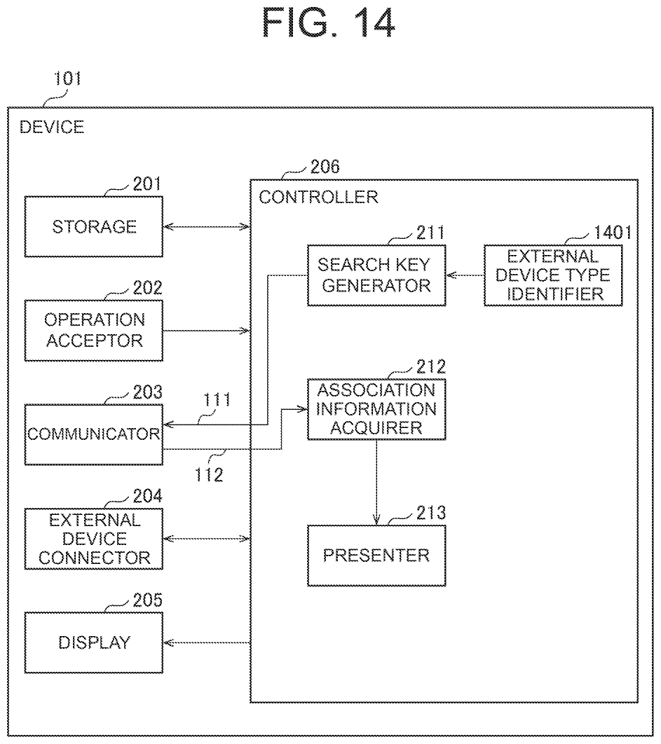

FIG. 15 is a diagram illustrating an example of a plurality of items of device information 1501 including a device type and tags attached to the individual items in the device 101. The plurality of items of device information 1501 indicate a model name, a language setting, a firmware version, an operation status, device details, a type of connection device, an external connection method, and a type of external device.

Among the plurality of items of device information 1501, the device information indicating the device details and the device information indicating the type of connection device indicate that the device 101 reproduces a BD player connected via HDMI. Furthermore, the device information indicating the external connection method indicates that the device 101 makes external connections via BLUETOOTH and HDMI_1. Furthermore, the device information indicating the type of external device indicates that the device is externally connected to an external speaker via BLUETOOTH, which is the first enumerated external connection method, among BLUETOOTH and HDMI_1.

As illustrated in FIG. 15, items of the model name, the language setting, the firmware version, the operation status, the device details, the type of connection device, the external connection method, and the type of external device are tagged with “model”, “language”, “version”, “status”, “detail”, “detail1”, “connection”, and “connection1” respectively.

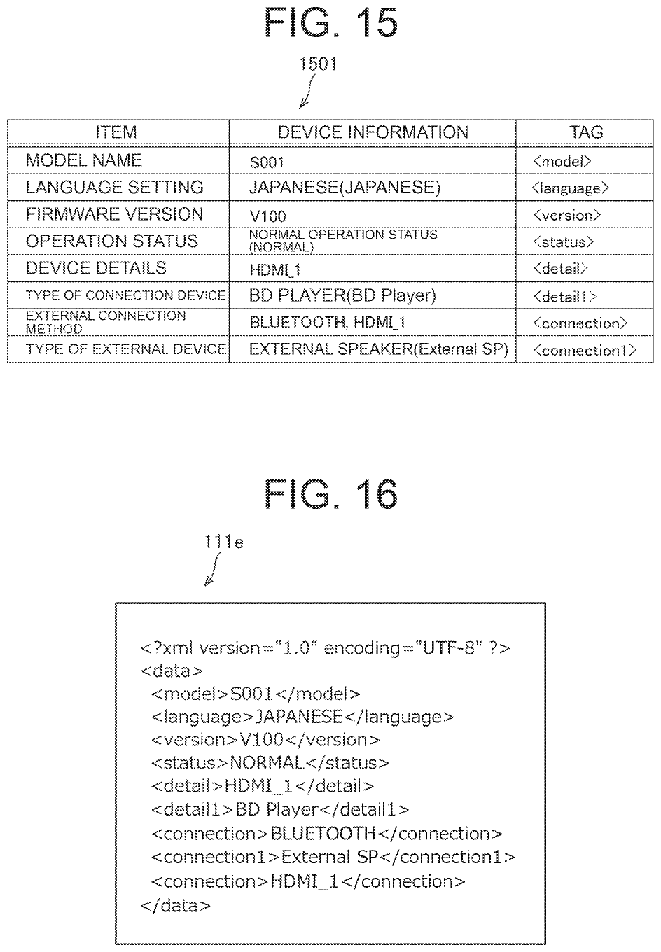

FIG. 16 is a diagram illustrating an example of a search key 111e including the plurality of items of device information 1501 illustrated in FIG. 15. The search key 111e illustrated in FIG. 16 shows the device information 1501 in the XML format, with the individual items tagged as illustrated in FIG. 15.

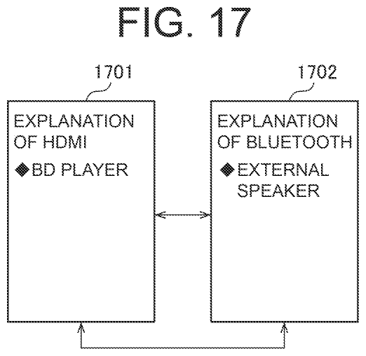

FIG. 17 is a diagram illustrating an example of presentation information 1701 and presentation information 1702 for individual external connection method.

The presentation information 1701 indicates association information 112 regarding a case of connection to a BD player via HDMI. For example, an explanation of HDMI shown in the presentation information 1701 indicates an explanation of a method for connection of the device 101 to a BD player via HDMI. Furthermore, the presentation information 1701 may indicate an explanation described in an instruction manual of the BD player, which is obtained by the association information extractor 513 by searching for a URL indicating the instruction manual of the BD player.

The presentation information 1702 indicates association information 112 regarding a case of connection to an external speaker via Bluetooth. For example, an explanation of BLUETOOTH shown in the presentation information 1702 indicates an explanation of a method for connection to an external speaker via Bluetooth. Furthermore, the presentation information 1702 may indicate an explanation described in an instruction manual of the external speaker, which is obtained by the association information extractor 513 by searching for a URL indicating the instruction manual of the external speaker.

As described above, according to the association information acquiring system 100 of this embodiment, the association information 112 is obtained in accordance with a type including a model of an external device connected to the device 101. In the association information acquiring system 100 of this embodiment, when the device 101 is connected to an external device, the association information 112 according to the type including the model of the connected external device can be presented to the user, along with the association information 112 according to the operation status of the device 101. Here, the server 102 acquires instruction manual data, etc. corresponding to the model of the external device via the Internet as the association information 112 and transmits the association information 112 to the device 101, so that even when a manufacturer providing the device 101 and a manufacturer providing the external device are different from each other, association information corresponding to the model of the external device can be presented to the user. Therefore, the association information acquiring system 100 in this embodiment can present the information required for the user in more detail than in the other embodiments, depending on the operation status and the external connection status of the device 101.

### Fourth Embodiment

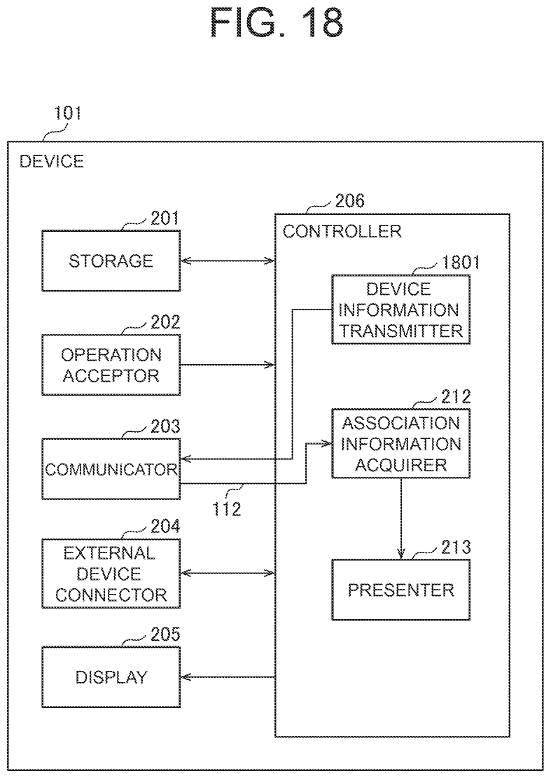

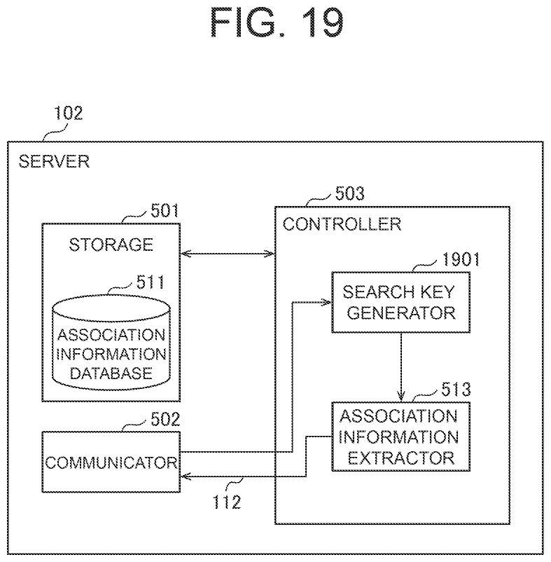

Referring to FIGS. 18 and 19, a fourth embodiment in which a server 102 generates a search key 111 will be described.

FIG. 18 is a block diagram illustrating an example of a configuration of a device 101 according to this embodiment. The configuration of the device 101 illustrated in FIG. 18 and the configuration of the device 101 illustrated in FIG. 2 are different from each other in that the device 101 illustrated in FIG. 18 includes a device information transmitter 1801 instead of the search key generator 211.

The device information acquirer 1801 acquires a plurality of items of device information and transmits the plurality of acquired items of device information to the server 102. For example, when an operation acceptor 202 receives a user operation of requesting association information 112, the device information transmitter 1801 acquires, from a storage 201, a plurality of items of device information corresponding to a status of the device at that time and transmits the plurality of acquired items of device information to the server 102. FIG. 19 is a block diagram illustrating an example of a configuration of the server 102 according to this embodiment. The configuration of the server 102 illustrated in FIG. 19 and the configuration of the server 102 illustrated in FIG. 5 are different from each other in that the server 102 illustrated in FIG. 19 includes a search key generator 1901 instead of the search key acquirer 512.

The search key generator 1901 acquires a plurality of items of device information and generates a search key 111 including the plurality of items of device information. The search key generator 1901 then transmits the generated search key 111 to an association information extractor 513.

Since the server 102 generates the search key 111, the device 101 can acquire the association information without performing the process of generating the search key 111. Accordingly, the association information acquiring system 100 according to this embodiment can reduce a processing load on the device 101.

### Fifth Embodiment

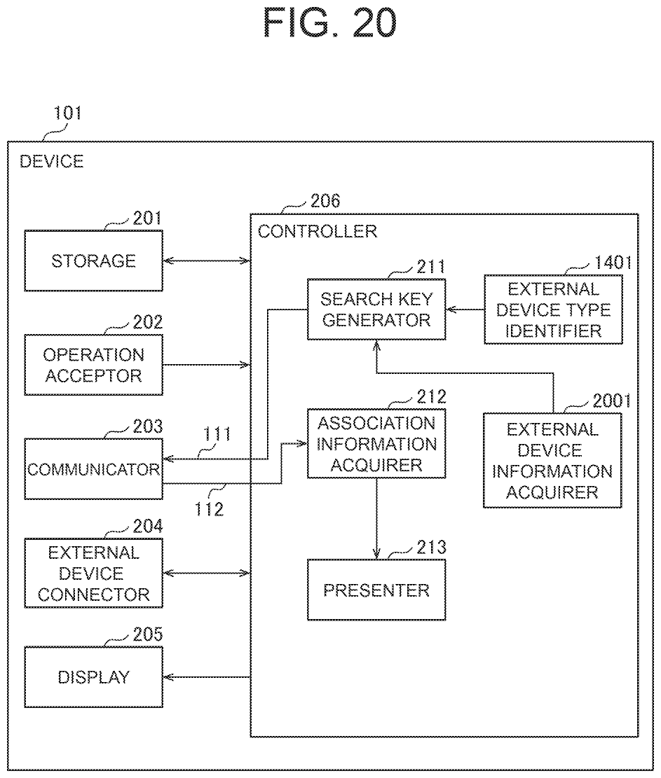

Referring to FIG. 20, a fifth embodiment will be described. Here, a device 101 acquires a device information indicating an operation status of an external device and presents association information in accordance with the operation status of the external device.

FIG. 20 is a block diagram illustrating an example of a configuration of the device 101 according to this embodiment. The configuration of the device 101 illustrated in FIG. 20 is different from the device 101 illustrated in FIG. 14 in that the device 101 illustrated in FIG. 20 has an external device information acquirer 2001 and the device 101 acquires device information including an item regarding an operation status of the external device and the presenter 213 presents association information 112 in accordance with the operation status of the external device.

The external device information acquirer 2001 acquires external device information indicating an operation status of the external device. For example, external device information indicates information about an error that has occurred in the external device. For example, when the external device information indicates the information about an error that has occurred in the external device, the external device information indicates an error code or the like. The external device information is presented in a format corresponding to a connection method between the device 101 and the external device.

The external device information acquirer 2001 acquires external device information by receiving external device information from the external device. Alternatively, the external device information acquirer 2001 may transmit a predetermined signal to the external device so as to acquire a response to the predetermined signal as external device information. Alternatively, the external device information acquirer 2001 may determine an operation status of the external device in accordance with a communication status between the device 101 and the external device, and generate external device information indicating the operation status of the external device. For example, the external device information acquirer 2001 may generate external device information indicating that the external device is in an error status when the external device information acquirer does not receive a predetermined signal from the external device.

When the external device information acquirer 2001 acquires the external device information, the device information includes an item regarding the operation status of the external device indicated by the external device information.

When the external device information acquirer 2001 acquires the external device information, the search key generator 211 of this embodiment generates a search key 111 including the item regarding the operation status of the external device indicated by the external device information. A search key generator 211 then sends the generated search key 111 to a server 102 via a network 103.

When the search key 111 according to this embodiment includes device information indicating a model name of the external device connected to the device 101 and the external device information, an association information extractor 513 acquires association information 112 associated with the external device information from an information processing apparatus that is different from the server 102, such as an information processing apparatus managed by a manufacturer of the external device.

For example, when the external device information indicates that the external device is in an error status, the association information 112 indicates a method for coping with the error of the external device. The presenter 213 then presents the association information indicating the method for coping with the error of the external device to the user so that the user can cope with the error that has occurred in the external device.

As described above, according to the association information acquiring system 100 of this embodiment, the association information 112 is obtained in accordance with the operation status of the external device. In the association information acquiring system 100 of this embodiment, the association information 112 according to the operation status of the connected external device can be presented to the user, along with the association information 112 according to the operation status of the device 101. Therefore, the association information acquiring system 100 in this embodiment can present the information required for the user in more detail than in the other embodiments, in accordance with the operation status of the external device.

Modifications

The following modification will be described. That is, a device 101 transmits device information including an item regarding an operation status of an external device to a server 102, and the server 102 receives the device information and generates a search key including an item regarding the operation status of the external device.

As a modification of the association information acquiring system 100 of the fifth embodiment, a device 101 may include a device information transmitter 1801 instead of the search key generator 211, as illustrated in FIG. 18, and the server 102 may include a search key generator 1901 instead of the search key acquirer 512, as illustrated in FIG. 19.

In the device 101 according to this modification, when the external device information acquirer 2001 acquires external device information, the device information transmitter 1801 transmits a plurality of items of device information including the acquired external device information to the server 102. The search key generator 1901 then receives device information including an item regarding the operation status of the external device from the device 101 so as to acquire the device information, and generates a search key 111 including the acquired device information. Accordingly, in the association information acquiring system 100 of this modification, the server 102 can generate the search key 111 including the item regarding the operation status of the external device.

The present disclosure is not limited to each of the above-described embodiments, and various modifications may be made thereto within the scope indicated by the claims. An embodiment that can be implemented by appropriately combining technical sections disclosed in the different embodiments also falls within the technical scope of the present disclosure. Furthermore, new technical features can be created by combining the technical sections disclosed in the embodiments.

What is claimed is:

1. A device comprising:
a search key generator that acquires a plurality of items of device information and generates a search key including the plurality of items of device information; and
a communicator that transmits the search key to a server that extracts association information associated with the search key and receives the association information from a server that stores the association information.

2. The device according to claim 1, wherein the plurality of items include at least one item selected from a group including an item regarding a setting status of the device, an item regarding an operation status of the device, and an item regarding an external connection status of the device.

3. The device according to claim 1, wherein the plurality of items include at least one item selected from a group including an item regarding a setting status of the device, an item regarding an operation status of the device, an item regarding an external connection status of the device, and an item regarding an operation status of an external device connected to the device.

4. The device according to claim 2, wherein the item regarding the external connection status includes one item selected from a group including a type of en external device connected to the device and an external connection method.

5. The device according to claim 2, wherein the association information includes information corresponding to at least one status selected from a group including the setting status, the operation status of the device, and the external connection status.

6. The device according to claim 3, wherein the association information includes information corresponding to at least one status selected from a group including the setting status, the operation status of the device, the external connection status, and an operation status of the external device.

7. The device according to claim 2, wherein, when an item of the device information regarding an operation status of the device indicates an error status, the search key includes device information indicating an error code and the association information includes information regarding the error to which the error code is assigned.

8. The device according to claim 1, wherein the search key generator acquires the plurality of items of device information, triggered by a user operation requesting the association information.

9. The device according to claim 1, further comprising a presenter that presents the association information to a user.

10. The device according to claim 7, wherein, when the communicator receives a plurality of pieces of association information regarding at least one of the items of device information, the presenter presents the plurality of pieces of association information.

11. A server comprising:
a search key acquirer that acquires a search key including a plurality of items of device information acquired by a device; and
an association information extractor that extracts, from a database including association information associated with a combination of device information, association information associated with a combination of device information that matches the device information included in the search key.

12. An association information acquiring system comprising:
a device comprising:
a search key generator that acquires a plurality of items of device information and generates a search key including the plurality of items of device information; and
a communicator that transmits the search key to a server that extracts association information associated with the search key and receives the association information from a server that stores the association information; and
a server comprising:
a search key acquirer that acquires a search key including a plurality of items of device information acquired by a device; and
an association information extractor that extracts, from a database including association information associated with a combination of device information, association information associated with a combination of device information that matches the device information included in the search key.

13. A device comprising:
a device information transmitter that acquires a plurality of items of device information and transmits the plurality of items of device information to a server that extracts association information; and
a communicator that receives, from a server that stores the association information associated with a search key including the plurality of items of device information, the association information.

14. The device according to claim 13, wherein the plurality of items include at least one item selected from a group including an item regarding a setting status of the device, an item regarding an operation status of the device, an item regarding an external connection status of the device, and an item regarding an operation status of an external device connected to the device.

15. The device according to claim 14, wherein the association information includes information corresponding to at least one status selected from a group including the setting status, the operation status of the device, the external connection status, and an operation status of the external device.

16. A server comprising:
a search key generator that generates a search key including a plurality of items of device information acquired by a device; and
an association information extractor that extracts, from a database including association information associated with a combination of device information, association information associated with a combination of device information that matches the device information included in the search key.

17. An association information acquiring system comprising:
a device comprising:
a device information transmitter that acquires a plurality of items of device information and transmits the plurality of items of device information to a server that extracts association information; and
a communicator that receives, from a server that stores the association information associated with a search key including the plurality of items of device information, the association information; and
a server comprising:
a search key generator that generates a search key including a plurality of items of device information acquired by a device; and
an association information extractor that extracts, from a database including association information associated with a combination of device information, association information associated with a combination of device information that matches the device information included in the search key.

18. An association information acquiring method comprising:
acquiring a plurality of items of device information;
generating a search key including the plurality of items of device information;
transmitting the search key to a server that extracts association information associated with the search key; and
receiving the association information from a server that stores the association information.

19. A non-transitory computer readable recording medium recording a program that causes a computer to execute:
acquiring a plurality of items of device information;
generating a search key including the plurality of items of device information;
transmitting the search key to a server that extracts association information associated with the search key; and
receiving the association information from a server that stores the association information.
